(19) United States
(12) Patent Application Publication
(10) Pub. No.: US 2026/0221746 A1
(43) Pub. Date: Jul. 30, 2026

(54) DUCT FOR RECEIVING ELECTRIC-VEHICLE CHARGING CABLES

(71) Applicant: KERBO CHARGE LTD, London (GB)

(72) Inventor: Adam STANLEY, London (GB)

(21) Appl. No.: 19/146,552

(22) PCT Filed: Dec. 22, 2023
(86) PCT No.: PCT/GB2023/053357

§ 371 Date: Jul. 9, 2025

(30) Foreign Application Priority Data
Jan. 9, 2023 (GB) 2300261.1

(51) Int. Cl. H02G 9/04; B60L 53/18; B60L 53/30; H02G 1/08; H02G 3/04; H02G 9/06

(52) U.S. Cl. CPC H02G 9/04; B60L 53/18; B60L 53/30; H02G 1/08; H02G 3/0418; H02G 3/0437; H02G 9/06

(57) ABSTRACT

A duct (200) for receiving e-vehicle charging cables, is provided. The duct is suitable for installation in a gully cut into a pavement. The duct (200) includes a cable receiving portion (230) and a cover (208) that is coupled to the cable receiving portion (230), wherein the cover (208) is movable between an open position in which the cable receiving portion (230) can receive an e-vehicle charging cable and a closed position, wherein the cover (208) is biased towards the closed position.

### FIELD OF THE INVENTION

The present invention relates to a duct for receiving an electric-vehicle (e-vehicle) charging cable. In particular, the present invention relates to a duct for receiving an e-vehicle charging cable, suitable for installation in a gully cut into a pavement.

### BACKGROUND

People rely on publicly available Electric Vehicle (EV) chargers to replenish batteries of their e-vehicles. However, due to high charging cost associated with such chargers and further due to their limited availability, people alternatively use home chargers to charge their e-vehicles.

The use of home chargers is a cost-effective option, but it is only currently convenient for residents that have access to off-street parking. Residents that don't have access to off-street parking and wish to use a home charger must trail their charging cable across the pavement in front of their house. This creates a trip hazard for pedestrians and the risk of a personal injury claim against the homeowner.

Therefore, it is an object of the present invention to address above-recited problems.

### SUMMARY

According to an aspect of the present invention, there is provided a duct for receiving an e-vehicle charging cable, suitable for installation in a gully cut into a pavement. The duct comprising a cable receiving portion and a cover that is coupled to the cable receiving portion, wherein the cover is movable between an open position in which the cable receiving portion can receive an e-vehicle charging cable and a closed position, wherein the cover is biased towards the closed position.

In this way, a duct can be provided with a cover that can be opened to admit a cable and will close automatically to seal the cable in the cable receiving portion. This improves ease of use because a user does not need to take an active step in closing the cover. It further improves safety for other pavement users and pedestrians as it eliminates the risk that the cover could be left in the open position where it might represent a trip hazard. This also provides an improved protection for cables that are received therein, from external objects.

Preferably, the cable receiving portion is open at both ends to allow the e-vehicle charging cable to pass through from one end to another end of the cable receiving portion. This is advantageous because the cable can be easily moved inside the duct to adjust the length of the cable required to reach to the e-vehicle. Further, it allows users to easily move the cable from the charger to the e-vehicle without obstructing the path of the pedestrians on the pavement. Optionally, the cable receiving portion may be opened at one end and closed at the other end.

Preferably, the cable receiving portion comprises a base section and two side sections. At least one of the two side sections may be connected to the base section with a flexible joint. In some examples, both of the two side sections may be connected to the base section with flexible joints. This construction with one or more lower corner connections being flexible is advantageous for manufacture because to create an extrusion with the hinge biased in the closed position or beyond the closed position so that it has a positive downwards force when horizontal thanks to being manufactured in a neutral at-rest position below the horizontal would be very difficult if the base and side-walls of the channel were manufactured in their final closed “U-shaped” position, leaving insufficient physical room for the extrusion tool and associated cooling and fluid flows around the hinge and cover portions of the tool. This also has advantages for storage and transportation because the cable receiving portion can be manufactured in a flat configuration and can then be easily bent into shape for installation in the gully.

Preferably, the duct further comprises at least one securing means, wherein the securing means is configured to engage with the base section and a side section which connected to the base section via the flexible joint, wherein the at least one securing means is configured to secure the side section in an assembled configuration relative to the base section for installation in the gully. Although it is easier to manufacture, transport, and store the cable receiving portion with one or both of the bottom corners made with flexible joints that can be folded after manufacture, this can present additional challenges during installation to constrain the duct while fitting, for example with masking tape, and remove the constraint after fitting. The securing means may advantageously allow the cable receiving portion to easily retain a shape which allows it to receive the cable therein (i.e., the assembled configuration), facilitating easier installation of the duct into the gully. Preferably, at least one of the side sections includes a projection that can engage respectively with corresponding projection on the base section. Optionally, the securing means may be configured to retain the at least one side section substantially perpendicular relative to the base section in the assembled configuration.

Preferably, the at least one securing means is arranged on an inner surface of the cable receiving portion. This may be advantageous to contain the securing means within the cable receiving portion, so no alterations need to be made to the gully to accommodate the duct.

Alternatively or in addition to the securing means, the duct may comprise a shaping member which is engageable with the two side sections to bias them towards each other. This allows the cable receiving portion, which is preferably supplied to users in the flat configuration, to easily attain a shape which allows it to receive the cable therein, this may be particularly advantageous for embodiments wherein the two side sections are connected to the base section with flexible joints.

Preferably, the shaping member of the duct comprises one or more lugs on its outer surface to engage with the gully. This is advantageous as it allows the shaping member to fit within the gully securely and easily without requiring any specialized effort during installation of the duct within the gully. The lugs can improve the engagement of the duct with the gully and with adhesives.

Preferably, the cable receiving portion of the duct comprises one or more lugs on an outer surface of each of the two side sections to engage with the shaping member. This allows the cable receiving portion to fit inside the shaping member tightly and securely, thereby leading to a cable receiving portion which stays stable in events when the cable is pushed inside or pulled out of the duct.

Alternatively, the cable receiving portion of the duct may comprise one or more lugs on its outer surface to engage with the gully, or with mortar or adhesive used to secure the duct within the gulley, or with asphalt laid up to the channel. This may be advantageous as it allows the duct itself to fit within the gully securely and easily without requiring any specialized effort during installation of the duct within the gully, and without requiring use of a shaping member. As above, the lugs can improve the engagement of the duct with the gully and with adhesives.

Preferably, the cover abuts at least one of the two side sections in the closed position. This is advantageous because the cover receives a support from the side section which abuts the cover, thereby leading to distribution of load which is applied on the cover. The side section which abuts the cover provides additional vertical support to the cover which helps in bearing the load, thereby leading to a robust duct for receiving the cable.

Preferably, the cover and the at least one side section abut one another along a contact path, wherein the contact path is angled with respect to the vertical. This is advantageous as the contact path guides the cable to slip inside the cable receiving portion when receiving the cable and further allows the cable to swiftly come out of the cable receiving portion when pulled out by the user, thereby providing an ease of use to the user. Further, it reduces stress which otherwise would have been applied on the cable while pulling the cable out from the cable receiving portion. However, the skilled person will understand that not all of the contact path need be angled necessarily. Indeed, the skilled person will understand that the edge surfaces between the cover and the at least one side section may be angled or shaped (curved) in any way to reduce abrasion, friction, or cutting of the cable as it passes through the opening between the cover and said side section.

Preferably, one of the side sections comprises a horizontal ledge that supports a portion of the cover in the closed position. In this way, a substantial portion of the cover rests on the ledge of the side section, which again allows distribution of the load being applied on the cover, without transferring lateral force onto the side of the duct. Thus, a robust and strong duct is provided which could take high amount of load, such as a pedestrian stepping on the cover of the duct, a vehicle driving over the duct or a heavy object being placed on the cover of the duct such as a parked vehicle or truck.

In some examples, the ledge has a curved side portion or surface, for example wherein the curved side portion or surface protrudes into the cable receiving portion of the duct. This may be advantageous to reduce abrasion of cables during insertion and removal of the cable into the duct.

Alternatively, or in addition, the free edge of the cover (e.g., an edge of the cover opposite to the edge coupled by a hinge) may comprise a curved portion or surface. Again, this may be advantageous to reduce abrasion of cables during insertion and removal of the cable into the duct, in particular where a cable would contact the cover, side section, and/or ledge, due to the closing force exerted by the cover, for example provided by a biased hinge. Indeed, the skilled person will understand that any edge surface between the cover and the at least one side section may be angled or shaped (curved) in any way to reduce abrasion, friction, or cutting of the cable as it passes through the opening between the cover and said side section. For example, this may include, but is not limited to, wherein at least one of (i) the side section which abuts the cover comprises a curved portion, wherein the curved portion is configured to be adjacent to the cover in the closed position; (ii) the ledge which supports a portion of the cover in the closed position comprises a curved portion; and/or (iii) an edge of the cover which abuts at least one of the two side sections, optionally including the ledge, has a curved edge portion.

Preferably, the cover comprises an upper surface which is textured. Optionally, this may include wherein the upper surface comprises grooves and/or a non-slip pattern. In this way, a strong grip is provided to a pedestrian stepping on the duct when installed within the gully. Alternatively, or in addition, the upper surface of the cover may comprise a non-slip material or coating, for example wherein the non-slip material or coating has a high friction coefficient to provide a strong grip to a pedestrian stepping on the duct.

Preferably, the cover is coupled with the cable receiving portion with a biased hinge. Additionally, the biased hinge is a living hinge. This is advantageous because the biased hinge allows the cover to be biased towards the closed position, which allows the cover to automatically return to the closed position. This improves an ease of use for a user because the user does not need to take an active step in closing the cover. Furthermore, the living hinge provides a flexible and elastic connection of the cover with the cable receiving portion of the duct. A living hinge is preferred because it does not involve any moving parts that could become separated, detached, corroded, obstructed, or degraded over time.

At least one of the side sections may include a projection that can engage with the cut gully and any sealant, mortar, asphalt or adhesive used during fitting or alternately can engage with a corresponding projection on the base section of the cable receiving portion when the duct is installed in the gully. In a more preferred arrangement, both of the side sections include projections that can engage respectively with corresponding projections on the base section. This arrangement can allow the side section and the base section to provide mutual structural support for one another. This can improve the robustness of the duct when installed in the gully to allow it to bear weight from pavement users, thereby mitigating any risk of collapse.

Preferably, the duct further comprises a cable guide member arranged adjacent to the biased hinge within the cable receiving portion, wherein the cable guide member is configured to divert a cable away from contacting the biased hinge. This may be advantageous to prevent the cable being pulled against the hinge or close to the hinge during removal of the cable from the duct which can stretch and damage the hinge. The cable guide member may be configured to prevent the cable from travelling directly upwards towards the hinge, instead diverting the cable towards the outer edge of the cover opposite to the hinge so that the cover can be pushed open by the cable without stretching and damaging the hinge. Preferably, the cable guide member may be configured to attach to a portion of the side section of the cable receiving portion. The cable guide member need not be present throughout the duct, but might only be present at the ends of the duct or at any location where the cable exits the duct. The cable guide member might be built into the cable receiving portion of the duct, or might be a separate part that is added to the cable receiving portion.

Alternatively or in addition to the cable guide member, the biased hinge may be arranged outside of an internal channel defined by the cable receiving portion, wherein the cable receiving portion comprises two side sections connected to a base section. Locating the hinge so it is not positioned above the internal channel may be advantageous to prevent the cable being pulled against the hinge during removal of the cable from the duct which can stretch and damage the hinge. For example, the hinge may be located over one of the side sections, or beyond the side section, outside of cable receiving portion.

The cover may be coupled to a first side section of the cable receiving portion via a biased hinge. In some examples, the biased hinge is recessed relative to an upper surface of the first side section. This may be advantageous as the cover may be configured to abut or contact a portion of the first side portion in the open position which may inhibit further rotation of the biased hinge. This may be advantageous to prevent the hinge being stretched beyond its elastic limit when rotated through too large an angle, thus recessing the hinge relative to an upper surface of the first side section may extend the usable life of the hinge. Over rotating and stretching the hinge can damage the hinge, resulting in the cover of the duct not fully closing, and thus causing a trip hazard in use.

Alternatively or in addition to recessing the hinge relative to an upper surface of the first side section, at least one of (i) the cover and (ii) the cable receiving portion may comprise a hinge limiting member, wherein the hinge limiting member is configured to inhibit rotation of the biased hinge beyond a predetermined threshold in the open position. As above, this may be advantageous to prevent the hinge being stretched beyond its elastic limit when rotated through too large an angle, thus recessing the hinge relative to an upper surface of the first side section may extend the usable life of the hinge.

For example, the hinge limiting member may be arranged on the cover such that the hinge limiting member is configured to abut a portion of the cable receiving portion in the open position to inhibit rotation of the biased hinge beyond a predetermined threshold. Alternatively, the hinge limiting member may be arranged on the cable receiving portion such that the hinge limiting member is configured to abut a portion of the cover in the open position to inhibit rotation of the biased hinge beyond a predetermined threshold. In some examples, each of the cover and the cable receiving portion may comprise a hinge limiting member, such that a first hinge limiting member is configured to abut a second hinge limiting member in the open position to inhibit rotation of the biased hinge beyond a predetermined threshold.

The hinge limiting member is preferably configured to limit maximum rotation of the biased hinge to less than the full 180 degrees in the open position relative to the closed position. More preferably, the hinge limiting member is configured to limit the maximum rotation of the hinge to significantly less than 180 degrees, for example wherein the hinge limiting member is configured to limit the maximum rotation of the hinge to somewhere between 20 degrees and 150 degrees in the open position relative to the closed position, depending on the mechanical design. This includes, but is not limited to, limiting the maximum rotation of the hinge to less than 120 degrees, less than 90 degrees, less than 45 degrees, or less than 20 degrees.

The cable receiving portion preferably has some flexibility such that the cable receiving portion is configured to conform with a surface of a pavement. This may be advantageous as the surface of a pavement is often uneven. Rigid ducts may therefore protrude from the uneven pavement surface at points, causing a trip hazard. Thus, providing the cable receiving portion with some flexibility to conform to undulations of a pavement surface can ensure that the cable receiving portion does not protrude, and that cover is also level with the pavement surface. For example, at least one of the base section and the two side sections may be made from a flexible or semi-flexible material, such as but not limited to rigid PVC or uPVC that, despite the material name including the word “rigid”, has significantly more flexibility than a solid metal duct. In areas with more extreme unevenness the duct can be adapted to flex even more by making vertical cuts perpendicular to the direction of the duct, for example up to approximately three quarters (or 75%) of the height of the duct from the base, to reduce the resistance of the side walls to flexing up or down at that point. This ability to slightly flex to match the undulations of an uneven or cambered pavement of walkway allows the channel to be installed more quickly, more cheaply, and with less asphalt reinstatement or repair to bring the surface in line with the cover of the duct without leaving any material changes in surface height that would constitute a trip hazard.

In some examples, the cover may comprise an aperture, wherein the aperture is configured to accommodate a cable, such as an e-vehicle charging cable, through the aperture whilst the cover is in the closed position. Preferably, the aperture is arranged at an end of the cover. Providing an aperture in the cover, for example at one or both ends, may be advantageous to allow a cable to exit the duct vertically, rather than horizontally, whilst the cover is in the closed position. Purely as an example, this may be particularly advantageous in cases where the duct is installed into a pavement adjacent to a step, such as a front doorstep, or a wall, such as a garden wall or building. Without the aperture, vertical exit of the cable causes the cover to be biased into the open position in the vicinity of the cable, creating a trip-hazard. This can also strain the hinge of the cover, causing the cover not to close completely even after the cable is fully removed. Providing the aperture in the cover overcomes these problems by enabling vertical exit of the cable without opening the cover relative to the cable receiving portion.

A cable guide member arranged within the cable receiving portion may also be provided, wherein the cable guide member is configured to divert a cable, such as an e-vehicle charging cable, through the aperture in the cover. For example, the cable guide member may be attached to a side portion of the cable receiving portion, preferably adjacent to the aperture in the cover. The cable guide member may be configured to prevent the cable from travelling directly upwards to contact the cover, instead biasing the cable underneath the cable guide member such that the cable is directed through the aperture and does not push the cover open near the exit point. The aperture in the cover may be configured to hold the cable in the correct position to interact with the cable guide member so as to not pull open the lid in the area left clear for the insertion and removal of the cable past the guide member. Adjacent to the guide member it may also be advantageous to have a section of the ledge or landing pad removed from the opposite side wall so that there is sufficient space to remove the cable past the cable guide member.

Additionally, or instead, the cable receiving portion may comprise at least one baffle, or preferably a plurality of baffles, wherein each baffle is configured to divert the cable in the cable receiving portion. For example, the at least one baffle may be configured to divert the cable through the aperture. Optionally, the at least one baffle may be configured to divert the cable underneath the cable guide. Each baffle may be configured to span substantially the full height of the cable receiving portion.

These adaptations such as the cable guide member, the baffles and aperture in the cover to facilitate vertical exit of the cable can be variously achieved as modifications performed to the end of a duct, such as any duct disclosed herein, or embodied in an additional part or several parts to be added or inserted at the end of any duct that requires it.

Preferably, the cover is configured to be flexible, for example wherein the cover is made from a flexible or semi-flexible material. The flexible cover may be configured such that a portion of the cover may remain in the closed position whilst a second portion of the cover is in the open position. This may be advantageous to enable one portion of the cover to be in the open position while the rest is in the closed position, in particular this may reduce the trip hazard to pedestrians on the pavement whilst a cable, such as an e-vehicle charging cable, is fed into, or removed from a section of the cable receiving portion further along the duct. For example, if a long duct, such as but not limited to 3 m or longer in length, was having the cable put in from the right side and had opened the cover at the right side, then the cover would not be open at the left side and thus not create a trip hazard for pedestrians or wheeled vehicles or mobility devices passing the left side. In the preferred embodiment the flexibility of the cover allows the cable to be fed into the duct and only require a short section of the cover to be deflected from the closed position, for example less than 0.5 m worth of cover would be deflected at a time while inserting a cable and the rest would be able to remain closed.

According to another aspect of the present invention, there is provided a pavement (or sidewalk, or footway, or paving, or asphalt, or concrete, or cement) section comprising the duct and a gully cut in the pavement section for receiving the duct. In this way, an arrangement is provided which allows easy connection of a charger to an e-vehicle without trailing a cable over the pavement and reduces the risk of a trip hazard for a pedestrian. A gully is cut in the pavement which is easy to make and does not require a deep cut in the pavement, thereby retaining aesthetics of the pavement and avoiding the need of heavy construction to be performed.

Preferably, the duct comprises two side sections with lengths that are substantially matched to a depth of the gully. In this way, the duct is properly aligned with the gully so that the duct could be snugged into the gully, without having any protruding side sections or any vertical displacement up or down between the pavement and duct which could be a trip hazard for pedestrians.

Preferably, the cover is substantially level with the surface of the pavement section when the duct is received within the gully. This is advantageous because a user can freely step on the duct without requiring the user to carefully tread on the pavement as in case of cables trailing on the pavement. For example, a person wearing high heels, with mobility issues or a person with limited vision could easily walk on the pavement and step on the cover of the duct as it is levelled with the pavement.

Whilst the duct described above comprises a cable receiving portion and a cover, the skilled person will understand that the cable receiving portion and cover may be manufactured and sold separately, for example wherein the cover may be coupled to the cable receiving portion during manufacture or during installation. This may also be advantageous to allow the cover, and optionally the hinge, to be replaced and recoupled to the cable receiving portion in the event that they are damaged, without replacing the cable receiving portion. In these examples where the hinge and cover are a separate part there would be no need for one or both of the lower corners to be flexible, and the lower section of the cable receiving channel could have rigid corners, wherein the only highly flexible joint would be the hinge, such as a living hinge, connecting the cover to the side. The design of the lower part of the channel could include the cable guide member to protect the hinge as a rigid integral part. To secure the cover and hinge to the lower “U shaped” or “C shaped” channel as well as optional interlocking structures or rails, manufacturer could use adhesive, securing pins, securing screws, or other means, to prevent the two sections sliding apart or pulling apart.

For example, according to another aspect of the present invention, there is provided a duct for receiving an e-vehicle charging cable, suitable for installation in a gully cut into a pavement, the duct comprising a cable receiving portion comprising two side sections connected to a base section, wherein at least one of the two side sections is connected to the base section with a flexible joint.

According to another aspect of the present invention, there is provided a duct for receiving an e-vehicle charging cable, suitable for installation in a gully cut into a pavement, the duct comprising a cable receiving portion, wherein at least a portion of the cable receiving portion is configured to be flexible such that the duct is configured to conform with a surface of the pavement.

For example, the cable receiving portion may comprise two side sections connected to a base section, wherein at least one of the base section and the two side sections is made from a flexible material such that the cable receiving portion is configured to conform with the surface of the pavement.

The cable receiving portion may further comprise an attachment means configured to be coupled to a cover, wherein, in use, the cover is movable between an open position in which the cable receiving portion can receive an e-vehicle charging cable and a closed position, wherein the cover is biased towards the closed position. Optionally, the attachment means may comprise a hinge. Alternatively, the cover may comprise a hinge, wherein the attachment means of the cable receiving portion may configured to couple to the hinge.

### BRIEF DESCRIPTION OF DRAWINGS

Embodiments of the invention are now described, by way of example, with reference to the drawings, in which:

FIG. 1 illustrates a general arrangement of a duct in a gully which is cut into a pavement, in a known configuration.

FIG. 2 is a schematic side view of a duct in a flat configuration, in an embodiment of the present invention.

FIG. 3 is a schematic end view of a duct in a shaped configuration together with an optional shaping member, when installed in a pavement, in an embodiment of the present invention.

FIG. 4 is a schematic side view of a duct in a flat configuration, in another embodiment of the present invention.

FIG. 5 is a schematic end view of a duct in a shaped configuration, in another embodiment of the present invention.

FIG. 6 is a schematic side view of a duct in a flat configuration, in one more embodiment of the present invention.

FIG. 7 is a schematic end view of a duct in a shaped configuration without an optional shaping member, in the one more embodiment of the present invention.

FIG. 8 is a schematic cross-sectional end view of a duct installed in a gully cut into a pavement constructed from paving stones, utilising extended lugs on the shaping member to secure a channel under neighbouring paving slabs, in an embodiment of the present invention.

FIG. 9 is a schematic cross-sectional end view of a duct in an assembled configuration, in another embodiment of the present invention.

FIG. 10 is a schematic side view of a duct in an unassembled configuration, such as the duct of FIG. 9, in an embodiment of the present invention.

FIG. 11 is a schematic detail view of a cross-sectional end view of a hinge of a duct, such as the duct of FIG. 9, in an embodiment of the present invention.

FIG. 12 is a schematic cross-sectional end view of a duct in an assembled configuration, such as the duct of FIG. 9, in an embodiment of the present invention.

FIG. 13A illustrates a top view of an end of a duct, in another embodiment of the present invention.

FIG. 13B illustrates a perspective view of the end of the duct shown in FIG. 13A.

FIG. 14 is a schematic of an insert for an end of a duct of the present invention, such as the duct of FIGS. 13A and 13B.

FIG. 15A is a schematic of a perspective view of an end of a duct of the present invention, shown without the cover, wherein the cable enters/exits the duct vertically.

FIG. 15B is a schematic of a top view of the duct of FIG. 15A, with the cover shown.

FIG. 16 is a schematic side view of a duct in an unassembled configuration, in another embodiment of the present invention.

FIG. 17A shows a schematic cross-sectional end view of a duct in an assembled configuration, wherein the duct assembly comprises two separate parts that are extruded separately and then subsequently joined together: a first part comprising the cover, hinge, and a vertical wall connection piece, and a second part comprising the cable receiving portion.

FIG. 17B shows a schematic cross-sectional end view of an alternative duct to FIG. 17A, wherein the alternative duct of FIG. 17B is also assembled from the two separate parts.

### DETAILED DESCRIPTION

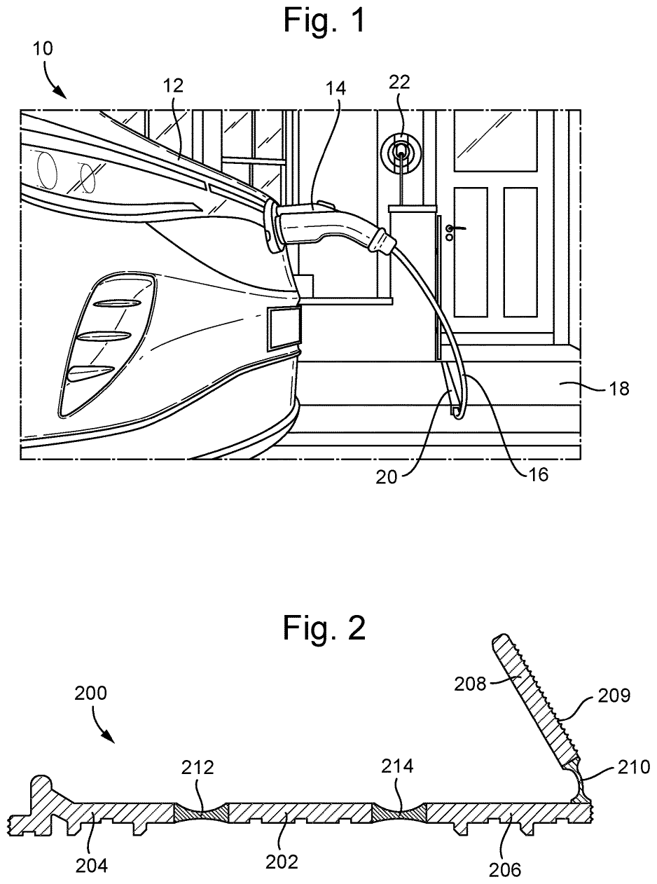

FIG. 1 illustrates a general arrangement (10) of a duct (20) in a gully which is cut into a pavement (18), in a known configuration. The arrangement (10) comprises a charger (14) which is connected to an e-vehicle (12). The charger (14) comprises a charging cable (16) which is connected to the charging plug (14) at one end and to a wall mounted unit (22) at the other end. The cable (16) passes through the duct (20) installed in a gully cut into the pavement (18).

FIG. 2 is a schematic diagram of a duct (200) in a flat configuration, in an embodiment of the present invention. The duct (200) comprises a base section (202) and two side sections i.e., a first side section (204) and a second side section (206). The two side sections (204, 206) are configured to be connected to the base section (202) with flexible joints (212, 214), respectively. The flexible joints (212, 214) may be made up of a flexible thermoplastic or a thin foldable section of rigid thermoplastic, and the two side sections (204, 206) may be made up of a rigid thermoplastic which is still semi-flexible, and is significantly more flexible than metal.

In the flat configuration, the base section (202) and the two side sections (204, 206) are connected such that the base section (202) and the two side sections (204, 206) are lying on a same axis. This is the configuration as the part is manufactured to provide sufficient space around the cover and hinge for the manufacturing tooling.

The duct (200) comprises a cover (208) having an upper surface (209) which is textured. The cover (208) is configured to be connected to one of the two side sections (204, 206) with a biased hinge (210). In FIG. 2, the cover (208) is connected to the second side section (206). However, as would be understood by a person skilled in the art, the cover (208) may also be connected to the first side section (204) instead of the second side section (206).

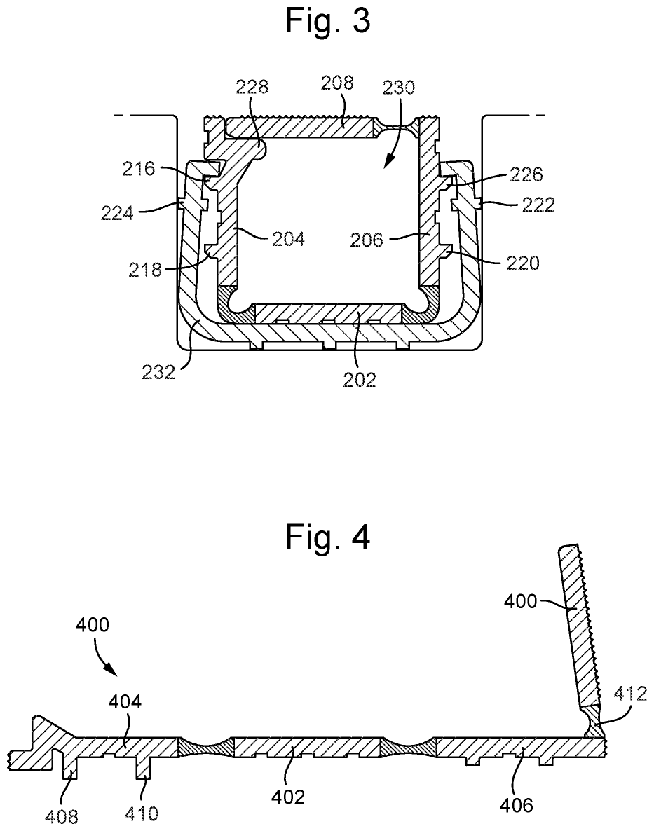

In this example, the biased hinge (210) is a living hinge. However, the hinge (210) may also comprise one or more hinges, as would be understood by a person skilled in the art. Further, the biased hinge (210) may comprise an elastomeric polymer (elastomer) such as Hytrel, or any other elastic material as would be understood by a person skilled in the art, and the part may be fabricated through one extrusion die utilising several different polymers, each polymer selected for the physical properties required of that section of the part, with in one example the elastomeric polymer used for the biased hinge (210). The natural neutral position of the hinge (210) in this case is clearly not at right angles to the side section (206), and is instead formed at an angle beyond the normal closed point, so that when the duct is in the final shaped configuration (for example shown in FIGS. 3,5,7,9,12) the hinge and lid are biased to push down to return to their original manufactured angle with some force towards the ledge (228) as shown on subsequent figures.

FIG. 3 is a schematic end view of the duct (200) in a shaped configuration when installed in a pavement, in an embodiment of the present invention. The duct (200) further comprises an optional shaping member (232) which is engageable with the two side sections (204, 206) to bias them towards each other, thereby holding them in the correct shape. When the first side section (204) and the second side section (206) are biased towards each other, a cable receiving portion (230) is defined by the side sections (204, 206) and the base section (202).

The first side section (204) comprises one or more lugs, such as lugs (216, 218), to provide better purchase with sealant or adhesive used in fitting the channel into the cut gully, or to engage with the optional shaping member (232). Similarly, the second side section (206) comprises one or more lugs, such as lugs (220, 222) to engage with the shaping member (232).

In the shaped configuration, the two side sections (204, 206) are biased towards each other, such that the two side sections (204, 206) are lying substantially at an inverted angle with respect to the base section (202).

The cover (208) is movable between an open position and a closed position, wherein the cover (208) is biased towards the closed position. Accordingly, when a user opens the cover (208) to put the charging cable (16) inside the duct (200), the cover (208) automatically returns to the closed position as the cover (208) is biased towards the closed position. In other words, the biased hinge (210) urges the cover (208) to return to the closed position. Thus, the user does not need to take an active step in closing the cover (208).

In the open position, i.e., when the user opens the cover (208) to put the charging cable (16) inside the duct (200), the cable receiving portion (230) of the duct (200) receives the charging cable (16).

In the closed position, the cover (208) abuts at least one of the two side sections (204, 206). In FIG. 3, it is shown that the cover (208) abuts the first side section (204). However, as would be understood by a person skilled in the art, the cover (208) may also abut the second side section (204) instead of the first side section (206).

The duct (200) further comprises a ledge with curved side (228) that supports a portion of the cover (208) in the closed position. When a force is exerted on the cover (208), such as when a pedestrian steps on it, the force is transmitted downwards via the ledge (228) and through the upstanding first side section (204). This provides a strong arrangement that ensures that the cover of the duct can withstand significant forces without collapsing. In the closed position, the charging cable (16) is securely contained within the duct (200) in the cable receiving portion (230) which protects the charging cable (16) from the risk of damage due to external objects. Further, the cable receiving portion (230) is open at both ends which allows the charging cable (16) to pass through from one end to another end of the cable receiving portion (230). In other embodiments the ends of the cable receiving portion (230) may be angled with respect to the main longitudinal channel so that the cable can be turned through one or more corners.

The shaping member (232) further comprises one or more lugs, such as lugs (224, 222) on its outer surface to engage with a gully cut into a pavement and/or to provide better engagement with any mortar or adhesive which can optionally be provided between the shaping member (232) and the gully. The lugs (224, 222) allow the shaping member (232) to fit closely into the gully which in turn provides stability to the cable receiving portion (230) while receiving and holding the charging cable (16).

FIG. 4 is a schematic diagram of a duct (400) in a flat configuration, in another embodiment of the present invention. The duct (400) is similar to the duct (200, 300) as described above, wherein the base section (402) corresponds to the base section (202) and two side sections (404, 406) correspond to the two side sections (204, 206), respectively.

However, the side section (404) of the duct (400) of the present embodiment, comprises two lugs (408, 410) which are longer than the lugs (216, 218) of the duct (200). The longer lugs (408, 410) allow the side section (404) to have a different level of engagement with a shaping member or with mortar or adhesive.

The duct (400) further comprises a biased hinge (412) which is shorter in length and having an increased thickness as compared to the biased hinge (210) of FIGS. 2 and 3.

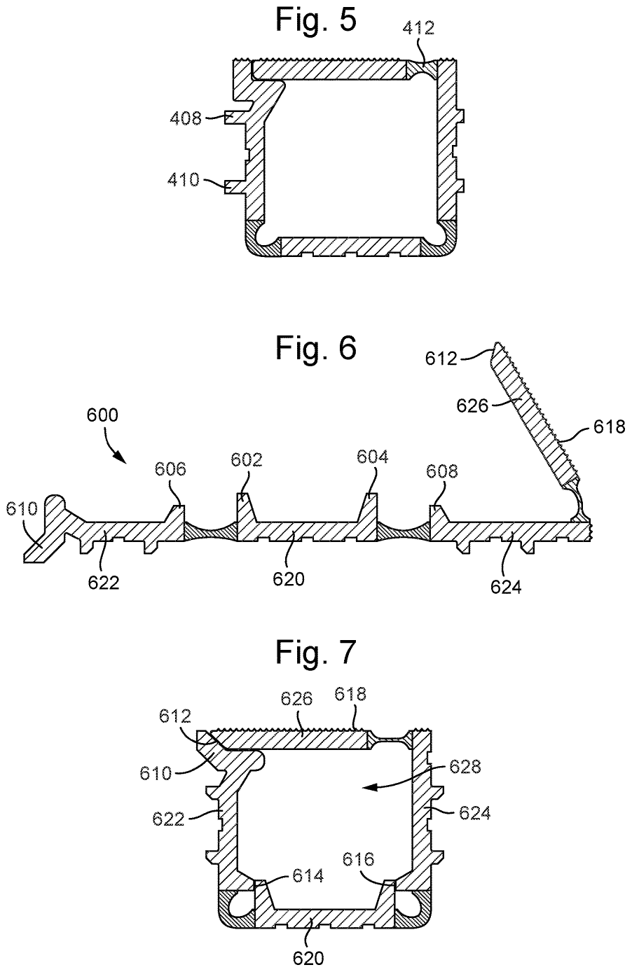

Further, a duct in FIG. 5 represents the duct of FIG. 4 in a shaped configuration and is similar to the duct of FIG. 3 as described above, except for the lugs (408, 410) which are longer in length than the lugs (216, 218) of the duct (200).

FIG. 6 is a schematic diagram of a duct (600) in a flat configuration, in one more embodiment of the present invention. The duct (600) is similar to the duct (200) as described above. On similar lines, FIG. 7 is a schematic diagram of the duct (600) in a shaped configuration, which is similar to the configuration of the duct (200) shown in FIG. 3.

Additionally, the duct (600) comprises corners (606, 602, 604, 608). More specifically, a base section (620) comprises two corners (602, 604) and two side sections (622, 624) comprise one corner (606, 608) each. Further, the duct (600) comprises an extension (610) extending from a side section (622).

In the shaped configuration, the corners of the base section (620) meet the corners of each of the side sections (622, 624) to define a closing. More specifically, the corners (602, 606) meet each other to define the closing (614) and the corners (604, 608) meet each other to define the closing (616). The closings (614, 616) defined by the corners when they meet, prevent a cable receiving portion (628) from skewing or becoming deformed into a trapezoid shape.

In one example, the corners (602, 606) and the corners (604, 608) comprise a hook which enables the corners (602, 606) and (604, 608) to click and lock together, thereby helping the side sections (622, 624) to hold at inverted angles with respect to the base section (620) to avoid deforming of the cable receiving portion (628).

In another example, the corners may be secured to each other by welding with heat or with an adhesive such as glue. Further, the closings (614, 616) help the side sections to hold at inverted angles to avoid deforming of the cable receiving portion (628). In one more example, the corners may be secured with sprung clips which snap fit with each other, preventing the cable receiving portion (628) from springing open as well as holding the side sections (622, 624) square with respect to the base section (620).

In the closed position, a cover (626) abuts one of the side sections. More specifically, an end (612) of the cover (626) is provided with a slope, wherein the end (612) abuts the extension (610) which is also aligned at an angle of the slope of the end (612), thereby defining a contact path between the end (612) and the extension (610). The contact path provides a safe exit and entry path for the charging cable (16) to prevent damage to the charging cable (16) from otherwise sharp corners of a side section and a cover when the charging cable (16) is pushed or pulled from the duct (600). In one example, the end (612) and the extension (610) have large radii which further helps in preventing the damage to the charging cable (16) from otherwise sharp corners of a side section and a cover.

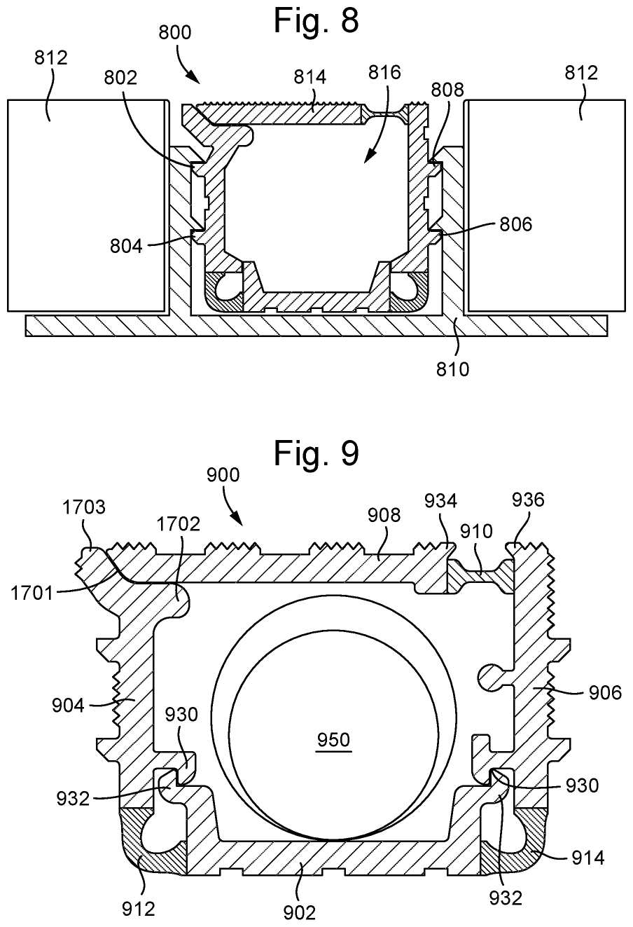

FIG. 8 is a schematic diagram of a duct (800) installed in a gully cut into a pavement, in an embodiment of the present invention. The duct (800) comprises lugs (802, 804, 806, 808) which enables the duct (800) to engage with a shaping member (810) or to engage directly with the gully or mortar or adhesive in the gulley. In one example, the lugs (802, 804, 806, 808) comprise a hook which enables the lugs (802, 804, 806, 808) to click and lock with the shaping member (810) or directly with the gully. In another example, the lugs (802, 804, 806, 808) may be engaged with the shaping member (810) by welding with heat or with an adhesive such as glue. In one more example, the lugs (802, 804, 806, 808) may be engaged within the gully using mortar or an adhesive and/or a sealant.

In one example, the shaping member (810) may be engaged within the gully using an interference contact. In another example, the shaping member (810) may include a wider base which engages beneath paving slabs (812) of the pavement.

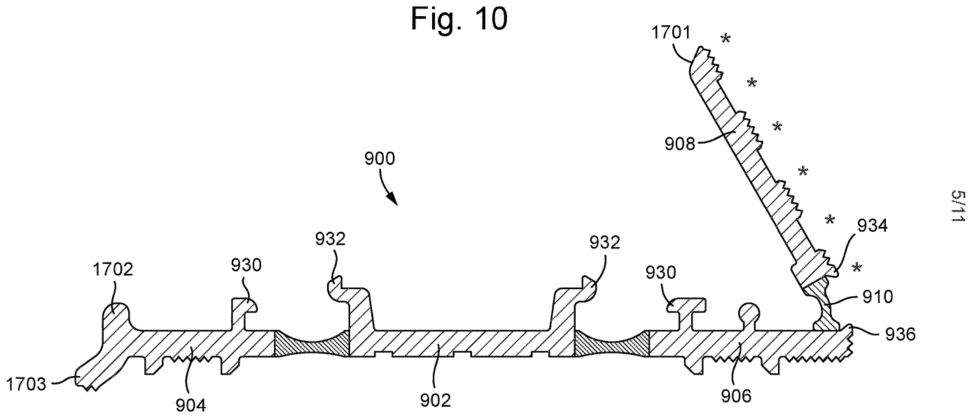

FIG. 9 is a schematic of another embodiment of a duct (900) in an assembled configuration. FIG. 10 is a schematic of the duct (900) of FIG. 9 in an unassembled configuration (or “flat” configuration). As shown in FIG. 9, in the assembled configuration, the duct (900) is configured to receive an e-vehicle charging cable (950).

The duct (900) is similar to the ducts (200, 400, 600) as described above, comprising a base section (902) and two side sections, i.e., a first side section (904) and a second side section (906). The two side sections (904, 906) are connected to the base section (902) with flexible joints (912, 914), respectively.

In the flat configuration, as shown in FIG. 10, the base section (902) and the two side sections (904, 906) are connected such that the base section (902) and the two side sections (904, 906) are lying on a same axis. By contrast, in the assembled configuration, as shown in FIG. 9, the two side sections (904, 906) are biased towards each other, such that the two side sections (904, 906) are substantially parallel with respect to each other, and substantially perpendicular with respect to the base section (902).

In the embodiment shown in FIGS. 9 and 10, each of the side sections (904, 906) comprise a securing structure (930), wherein the securing structure (930) is arranged on the inner surface of the side sections (904, 906). The base section (902) also comprises two corresponding securing structures (932), arranged on the inner surface of the base section (902). The securing structures (930) of the side sections (904, 906) are configured to engage with the corresponding securing structures (932) of the base section (902) in the assembled configuration. In the example shown, each corner formed between the base section (902) and one of the side sections (904, 906) comprises a clip configured to engage, for example, by a snap-fit engagement. The engagement of the securing structures (930, 932) is configured to secure the respective side section (904, 906) in the assembled configuration relative to the base section (902) and prevent the flexible joints (912, 914) from collapsing back into the unassembled, flat configuration. The skilled person will understand that the clip securing structures (930, 932) shown in FIGS. 9 and 10 are merely one example and that securing structures may be fastened in any other way, including but not limited to with different shapes and/or engagement geometries, or mechanical fasteners such as pegs or screws. Alternatively, the securing structures may be configured to be bonded together, for example with adhesive, or heat or friction welding.

The duct (900) further comprises a cover (908) connected to the second side section (906) with a biased hinge (910). In this example, the biased hinge (910) is an elastomeric material. Although flexible polymers and elastomers can be resilient to millions of cycles of folding, they can be stretched beyond their elastic limit if they are rotated through too large an angle, resulting in the cover (908) of the duct (900) not closing fully after it has been over-rotated through, for example, approximately 180 degrees. To prevent over-rotation of the hinge (910), in the embodiment shown in FIGS. 9 and 10, the elastomeric hinge (910) is arranged to be below the upper surface of the cover (908) and the second side section (906). The gap created by recessing the hinge (910) below the upper surface of the cover (910) can be repeated as a shaping feature across the surface of the cover to additionally provide anti-slip features. In addition, the upper corner of the cover (908) adjacent to the hinge (910) and the upper corner of the second side section (906) adjacent to the hinge (910) each further comprise a hinge limiting protrusion (934, 936). The hinge limiting protrusions (934, 936) extend towards each other, but preferably do not protrude above the upper surface of the cover (908) or the upper surface of the second side section (906) to avoid introducing a trip hazard.

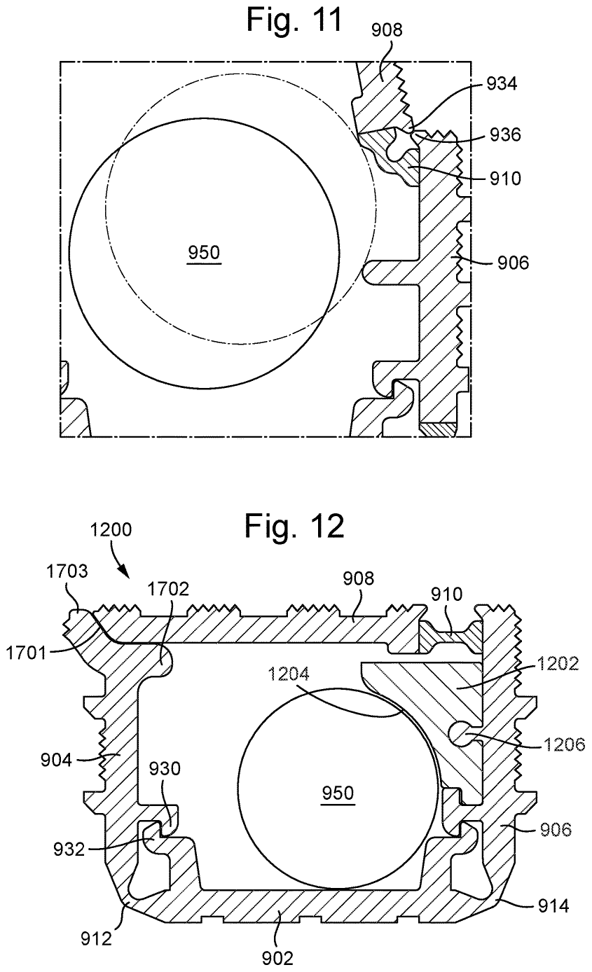

The hinge limiting protrusions (934, 936) are configured to contact each other when the cover (908) and hinge (910) are rotated to a certain point relative to the second side section (906). This is shown in the detailed view of FIG. 11.

In this particular embodiment, the hinge limiting protrusions (934, 936) are configured to contact each other and prevent further rotation when the hinge (910) reaches approximately 85 degrees of rotation relative to the closed position. However, the skilled person will understand that the hinge limiting protrusions may have different shapes and geometries, and may therefore be configured to prevent further rotation at other degrees of rotation less than 180 degrees, preferably limiting to maximum rotation at limits between 150 degrees or as little as 20 degrees, depending on the mechanical design.

FIG. 12 is a schematic cross-sectional end view of a duct (1200) in an assembled configuration. The duct (1200) is similar to the duct (900) of FIG. 9, discussed above. In addition, the duct (1200) comprises a cable guide structure (1202). The cable guide structure (1202) is arranged in an upper corner of the duct (1200), between the cover (908) and the side section which is coupled to the cover by the hinge (910). In this embodiment, the cable guide structure (1202) extends from the second side section 906 such that the cable guide structure (1202) is arranged below the hinge (910). The cable guide structure (1202) is configured to accommodate at least a portion of the cable (950) within the cable receiving portion below it.

The cable guide structure (1202) preferably comprises a curved surface (1204) facing the interior of the duct (1200). As a cable, such as cable (950), is removed from the duct (1200) during use, the surface (1204) of the cable guide structure (1202) is configured to divert the cable towards the outer edge of the cover (908) (i.e. the edge of the cover (908) which is not coupled to the hinge (910)). This may be advantageous to enable the cover (908) to be pushed open by the cable (950) without stretching and damaging the hinge (910). In the embodiment shown, the curved surface (1204) may be concave, preferably having a radius of curvature approximate to the radius of the cable (950). However, the skilled person will understand that in other embodiments the cable guide structure (1202) may comprise a sloped surface, flat surface, or other curved surfaces, including a convex surface.

In the embodiment shown in FIG. 12, the cable guide structure (1202) is mechanically coupled to the second side section 906, for example via a track and rail coupling (1206). However, the skilled person will understand that in other examples, the cable guide structure (1202) may be integrated into one of the two side sections (904, 906), or coupled in any other way, such as but not limited to by way of adhesive, or other mechanical coupling such as a clip, screw, or peg.

It will also be understood that the cable guide structure (1202) need not extend continuously across the length of the duct (1200) and/or side section (906). In some embodiments, the duct (1200) may comprise a plurality of cable guide structures (1202) at one end, both ends, or spaced across the length of the duct (1200) and/or side section (906).

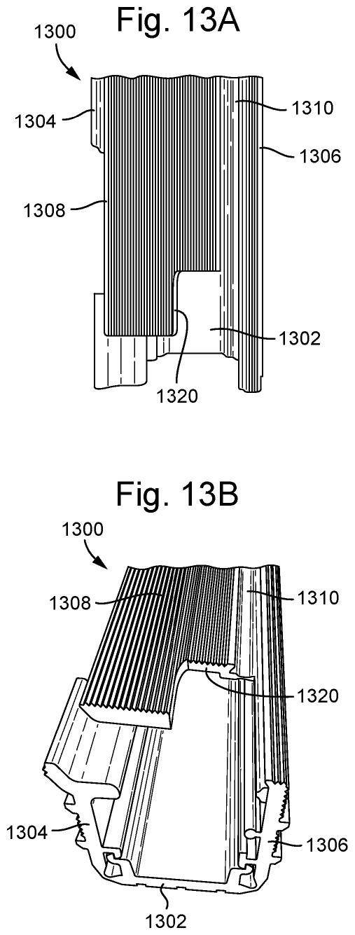

FIGS. 13A and 13B illustrate a top view and a perspective view of an end of a duct (1300). The skilled person will understand that the duct of FIGS. 13A and 13B may be any of the embodiments described above. In particular, the duct (1300) comprises a comprising a base section (1302) and two side sections, i.e., a first side section (1304) and a second side section (1306). The duct (1300) further comprises a cover (1308) connected to the second side section (1306) with a hinge (1310). In this embodiment, the cover (1308) comprises an aperture (or removed portion) (1320) at at least one end.

The aperture (or removed portion) (1320) has a width at least equal to the diameter of the cable which the duct is configured to receive, such as an e-vehicle charging cable. Providing an aperture (1320) in the cover (1308) may be advantageous to allow a cable to exit the duct (1300) vertically, rather than horizontally, whilst the cover (1308) is in the closed position.

FIGS. 13A and 13B show a normal duct that has been modified to exhibit the features described to facilitate vertical exit of the cable, by having the hinge protecting cable guide set just underneath the extreme of the aperture, and also the removed section of side wall (1304) to enable easier removal of the cable past the cable guide. It should be noted that at least a portion of the aperture is substantially aligned with the edge of the cover adjacent to the hinge to align the cable with the hinge protection cable guide when the cover is closed, however the aperture is also sized and configured such that there is also a sufficient gap for the cable to exit completely past the cover when the cover is opened. For example, as shown in FIGS. 13A and 13B the cover terminates before the end of the cable receiving portion, wherein the aperture is connected to the terminal end of the cover, to enable a cable to exit the cable receiving portion past the cover when the cover is opened.

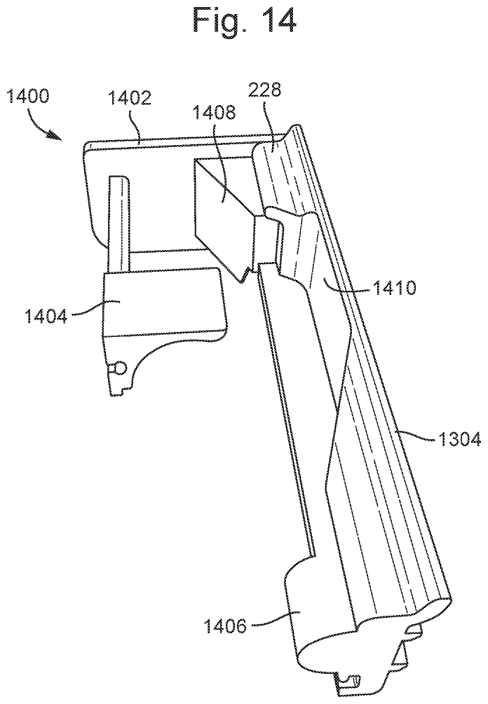

FIG. 14 shows an insert (1400) configured to be slid into the end of a duct, such as the duct (1300). The insert (1400) comprises an end plate (1402) configured to provide a terminal end to the cable receiving portion of a duct. The insert (1400) further comprises a cable guide structure (1404), similar to cable guide structure (1202) described above. The cable guide structure (1404) is spaced apart from the end plate (1402) to accommodate the aperture (or removed portion) (1320) in the cover (1308). The cable guide structure (1404) is configured to be arranged within the cable receiving portion of a duct, adjacent to the cover (1308) in the closed position, such that a cable may be accommodated underneath the cable guide structure (1404).

The insert (1400) also comprises a first baffle (1406) and a second baffle (1408). The first baffle (1406) is configured to be arranged adject to the opposite side section to the cable guide structure (1404) and protrude into the cable receiving portion of the duct. As such, the first baffle (1406) is configured to divert the cable underneath the cable guide structure (1404) when the cable is pulled taught. The second baffle (1408) comprises an angled corner piece adjacent to the end plate (1402), wherein the second baffle (1408) is configured to be arranged adjacent to the opposite corner to the aperture (1320) in the cover (1308). As such, the second baffle (1408) is configured to divert the cable underneath the cable guide structure (1404), and through the aperture (1320) when the cable is pulled taught.

Optionally, the side section (1304) opposite to the cable guide member (1404) may comprise a partially removed section (1410). This may be advantageous such that the cable can get in and out of the cable receiving portion past the cable guide member (1404), during introduction or removal or a cable from the duct. In the example shown in FIG. 14, the partially removed section (1410) comprises a removed section of the ledge (228) that supports a portion of the cover (1308) in the closed position.

Whilst the internal duct features of FIG. 14 are described as being integrated into an integrated insert (1400), the skilled person will understand that the internal duct features, such as but not limited to the cable guide structure (1404) and the plurality of baffles (1406, 1408), may alternatively be individually fitted into the cable receiving portion of a duct.

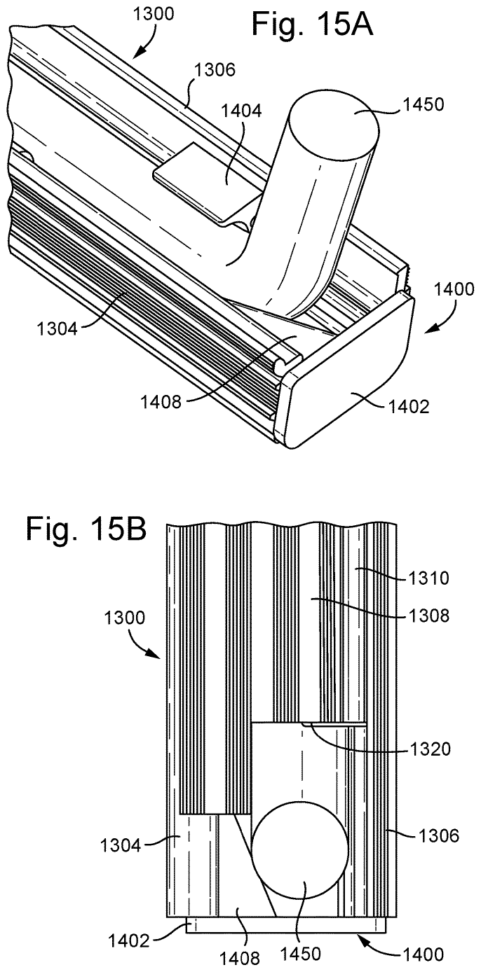

FIGS. 15A and 15B illustrate an end of a duct (1300), wherein the end of the duct (1300) comprises the insert (1400) of FIG. 14. A cable (1450), such as an e-vehicle charging cable, enters and/or exits the cable receiving portion of the duct (1300) vertically, through an aperture (1320) in the cover (1308).

The cable (1450) is biased towards the aperture by at least one baffle (1408) and the cable guide structure (1404).

The insert in this example is configured to engage and slide onto on the lower corner fixing clips of the base (such as securing structures (932)) that would have connected to the side wall (1304). To accommodate the insert, a short section of the side wall (1304) may be removed where the insert is added. The insert in this example is configured to engage and slide onto the hinge protector guide member rail (such as rail coupling (1206)) on the other side wall (1306).

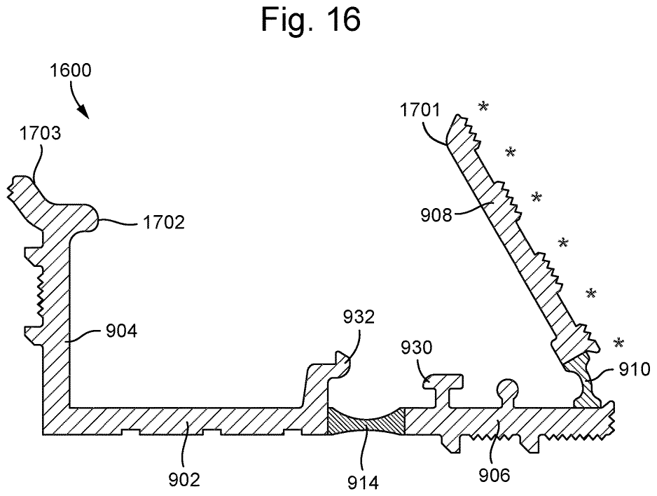

The embodiments above are disclosed wherein two side sections (204, 206; 404, 406; 904, 906) are each coupled to a base section (202; 402; 902) via flexible corner joints (212, 214; 912, 914). However, the skilled person will understand that in other embodiments, only one of the two side sections may be coupled to the base section via a flexible corner joint. For example, FIG. 16 is a schematic side view of a duct (1600) in an unassembled configuration, in another embodiment of the present invention. a first side section (904) may be rigidly fixed relative to the base section (902), for example wherein the first side section (904) is formed in a single piece. As shown in FIG. 16, the first side section (904) is arranged substantially perpendicular to the base section (902), both in the unassembled configuration and the assembled configuration (not shown). The second side section (906) is coupled to the base section (902) via the flexible joint (914). In the unassembled configuration, the base section (902) and the second side sections (906) are connected such that the base section (902) and the second side section (906) are lying on a same axis. By contrast, in the assembled configuration (not shown), the second side section (906) is biased towards the first side section (904), such that the two side sections (904, 906) are substantially parallel with respect to each other, and substantially perpendicular with respect to the base section (902).

The second side section (906) comprises a securing structure (930) arranged on the inner surface of the side section (906). The base section (902) also comprises a corresponding securing structures (932), arranged on the inner surface of the base section (902). The securing structure (930) of the second side section (906) is configured to engage with the corresponding securing structure (932) of the base section (902) in the assembled configuration, as described above.

Manufacturing the duct in an unassembled configuration comprising at least one flexible corner joint (912; 914) may be advantageous to enable the biased hinge (910) to be formed in a single die alongside the rest of the duct. By manufacturing in the unassembled configuration having a flexible corner joint on at least the same side section as the biased hinge (910), this allows enough space around the hinge (910) and cover (908) for the tool parts and cooling to manufacture the cover (908) in a biased position, folded beyond the horizontal position, so that there is sufficient force in the hinge (910) to keep the duct biased closed against any upwards forces from the cable within the duct.

Notwithstanding the above, the skilled person will understand that in other embodiments, the cable receiving portion of the duct, comprising two side sections and a base section, may be manufactured separately to the cover and/or hinge, wherein the cover and/or hinge are configured to be attached to one of the side sections of the cable receiving portion during assembly of the duct. In such examples, both of the two side sections may rigidly fixed relative to the base section, neither requiring a flexible corner joint to couple to the base section.

In use, in any of the embodiments described above, a user can lift the cover (208, 400, 626, 814, 908, 1308) of the duct (200, 400, 600, 800, 900, 1200, 1300, 1600) so that a cable can be received safely in the cable receiving portion (230, 628, 816). When the user lets go of the cover (208, 400, 626, 814, 908, 1308), it is automatically returned to a closed position because of the biasing effect of the living hinge (210, 412, 910, 1310). This ensures that the cable is protected within the duct (200, 400, 600, 800, 900, 1200, 1300, 1600), while also ensuring that the cover (208, 400, 626, 814, 908, 1308) is closed so that it does not present an obstacle or a trip hazard for other pavement users.

If the user pulls the cable out with sufficient force to ease open the cover, it can pass out of the duct without the user needing to manually open the cover.

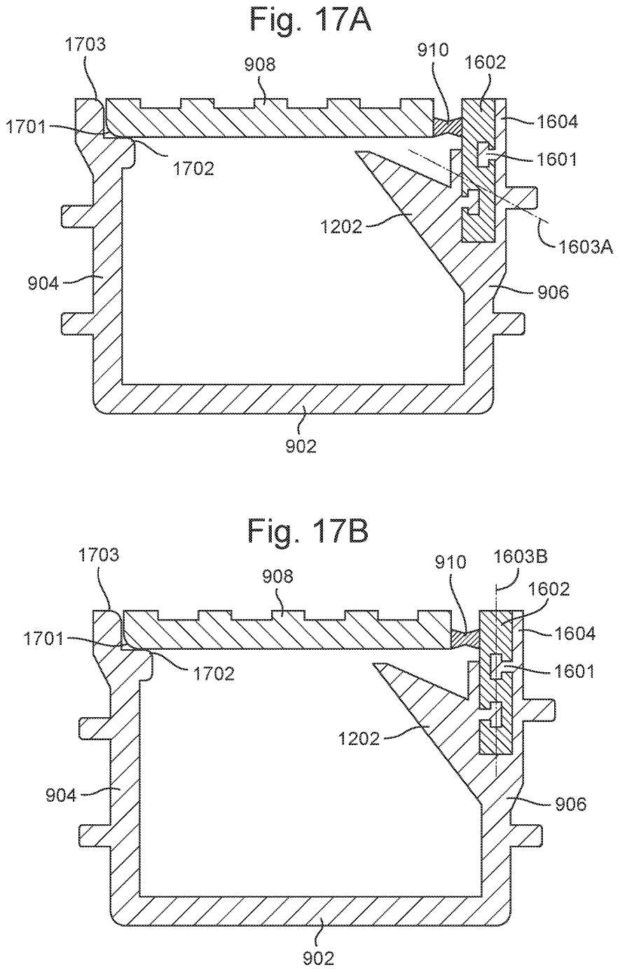

FIGS. 17A and 17B show two alternative duct assemblies each made of two parts. The first part comprises the cover (908), hinge (910), and a vertical wall connection piece (1602). The second part comprises the base (902) and two side sections (904, 906) of the cable receiving portion. The first and second parts are extruded separately and then joined together, either prior to installation or after installation. Advantageously, this may enable the first part (including the top cover) to be replaced after installation in case of damage. The second part in this example includes an extended side-wall (1604) arranged on the outer surface of the side section 906 to ensure that any adhesive or mortar securing the duct into a gulley cut into the pavement will not adhere to or secure the replaceable first part, including the cover (908) and hinge section (910), so that the replaceable first part can be slid out and replaced from the second part. The replaceable first part could be secured to the second part by interlocking sliding rails (1601) in the direction of the extrusion. Optionally, the first part may be further secured and prevented from sliding apart during use by the use of adhesives or securing members, pins or screws that could be inserted horizontally, vertically or at an angle in the direction orthogonal to the extrusion direction ensuring that they engage with both the first part and the second part.

The dashed lines show two possible, but not exhaustive, directions that a hole could be provided or drilled to allow a mechanical fastening means, such as a pin or screw, to be inserted through to prevent the two parts from sliding apart in the direction of the extrusion. In particular, FIG. 17A shows the dashed line (1603A) at roughly 45 degrees relative to the side wall (906), that can be accessed and drilled when the cover (908) is opened. FIG. 17B shows the dashed line (1603B) arranged vertically, parallel to the side wall (906), which can be accessed from above even when the channel cover (908) is closed. A duct may optionally use just one securing means, such as a pin or screw, or several along the length of the duct. The securing means, such as pins or screws, may be initially fitted in the factory, or might only be added during installation.

The examples of FIGS. 17A and 17B show the optional cable guide member (1202) integrated into the section for protecting the hinge (910). FIGS. 17A and 17B also show an example of securing rails (1601) using two “T” shaped extrusion sections with a corresponding “T” shaped slot in the vertical wall connection piece (1602) to slide into. However, the person skilled in the art would understand that there are many alternative interlocking shapes that could be used, including but not limited to alternative slot and rail geometries.

FIGS. 17A and 17B also illustrate a curved surface (1701) on the underside of the free edge of the cover (908) (i.e., the edge not coupled via the hinge (910)). In addition, FIGS. 17A and 17B also show a curved surface (1702) on the edge of the support ledge, and an optional curved surface (1703) on the upper edge of the sidewall adjacent to, but not coupled to, the cover (908), in this example the top right edge of the left wall (904) that faces the cover (908). The provision of each of these curved surfaces may advantageously reduce abrasion of any cable entering or leaving the duct, in particular the curved surfaces illustrated in FIGS. 17A and 17B (1701, 1702, 1703) may be arranged on surfaces where a cable would contact the duct thanks to the biased hinge (910) which exerts a closing force on the cover (908).

1-26. (canceled)

27. A duct for receiving an e-vehicle charging cable, suitable for installation in a gully cut into a pavement, the duct comprising a cable receiving portion and a cover that is coupled to the cable receiving portion, wherein the cover is movable between an open position in which the cable receiving portion can receive an e-vehicle charging cable and a closed position, wherein the cover is biased towards the closed position; and
wherein the cable receiving portion comprises two side sections, and wherein the cover abuts at least one of the two side sections in the closed position; the duct further comprising at least one selected from the group consisting of:
(i) one of the two side sections which abuts the cover comprises a curved portion, wherein the curved portion is configured to be adjacent to the cover in the closed position; and
(ii) an edge of the cover which abuts at least one of the two side sections has a curved portion.

28. The duct of claim 27 wherein the one of the two side sections which abuts the cover comprises a ledge that supports a portion of the cover in the closed position, and wherein the ledge comprises the curved portion.

29. The duct of claim 27, wherein the cable receiving portion is open at both ends to allow the e-vehicle charging cable to pass through from one end to another end of the cable receiving portion.

30. The duct of claim 27, wherein the cable receiving portion two side sections are connected to a base section, wherein at least one of the two side sections is connected to the base section with a flexible joint; optionally wherein the base section is connected via the flexible joint to a first end of a first side section of the two side sections, and the cover is connected to a second end of the first side section.

31. The duct of claim 30 wherein the two side sections are each connected to the base section respectively with a flexible joint.

32. The duct of claim 30 further comprising at least one securing means engageable with the base section and the at least one side section connected to the base section via the flexible joint, wherein the at least one securing means is configured to secure the at least one side section in an assembled configuration relative to the base section; optionally wherein the at least one securing means are arranged on an inner surface of the cable receiving portion.

33. The duct of claim 27, wherein the cable receiving portion of the duct comprises one or more lugs on an outer surface of each of the two side sections to engage with the gully cut into the pavement or to engage with any mortar, adhesive or fixing substance used to secure the duct into the gulley cut into the pavement.

34. The duct of claim 27, wherein the cover and the at least one side section which the cover abuts in the closed position abut one another along a contact path, wherein the contact path is angled with respect to the vertical.

35. The duct of claim 27, wherein the cover comprises an upper surface which is at least one selected from the group consisting of textured, grooved, formed with a non-slip pattern, or a non-slip material.

36. The duct of claim 27, wherein the cover is coupled with the cable receiving portion with a biased hinge.

37. The duct of claim 36 further comprising a cable guide member arranged adjacent to the biased hinge within the cable receiving portion, wherein the cable guide member is configured to divert a cable away from contacting the biased hinge and/or contacting the cover adjacent to the biased hinge.

38. The duct of claim 36 wherein the two side sections are connected to a base section, and
(i) wherein the two side sections connected to the base section define a channel, and wherein the biased hinge is arranged outside of the channel; or
(ii) wherein the cover is coupled to a first of the two side sections via the biased hinge, and wherein the biased hinge is recessed relative to an upper surface of the first side.

39. The duct of claim 36 wherein at least one of (i) the cover and (ii) the cable receiving portion comprises a hinge limiting member configured to inhibit rotation of the biased hinge beyond a predetermined threshold in the open position.

40. The duct of claim 27 wherein:
(i) the cable receiving portion comprises the two side sections connected to a base section, and wherein at least one of the base section and the two side sections is made from a flexible or semi-flexible material; and/or
(ii) the cover is configured to be flexible or semi-flexible.

41. The duct of claim 27 wherein the cover comprises an aperture, wherein the aperture is configured to accommodate a cable through the aperture whilst the cover is in the closed position.

42. The duct of claim 27 further comprising a cable guide member arranged within the cable receiving portion and adjacent to a portion of the cover, wherein the cable guide is configured to divert an e-vehicle charging cable away from contacting the portion of the cover.

43. A pavement section comprising the duct of claim 27 and a gully cut in the pavement section for receiving the duct.

44. A duct for receiving an e-vehicle charging cable, suitable for installation in a gully cut into a pavement, the duct comprising a cable receiving portion comprising two side sections connected to a base section, wherein at least one of the two side sections is connected to the base section with a flexible joint.

45. A duct for receiving an e-vehicle charging cable, suitable for installation in a gully cut into a pavement, the duct comprising a cable receiving portion comprising two side sections connected to a base section, and wherein at least a portion of the duct is configured to be flexible or semi-flexible such that the duct is configured to conform with a surface of the pavement.

46. The duct of claim 27 wherein cable receiving portion further comprises an attachment means, wherein the attachment means is configured to permanently or reversibly couple a cover to the cable receiving portion, wherein the cover is movable between an open position in which the cable receiving portion can receive an e-vehicle charging cable and a closed position, wherein the cover is biased towards the closed position.
